(19) United States
(12) Patent Application Publication
(10) Pub. No.: US 2020/0242688 A1
(43) Pub. Date: Jul. 30, 2020

(54) SYSTEM AND METHOD FOR REMOTELY PROCESSING APPLICATIONS BASED ON AN ASSOCIATED PHYSICAL ITEM

(71) Applicant: The Toronto-Dominion Bank, Toronto (CA)

(72) Inventor: Miguel NAVARRO, Ewing, NJ (US)

(73) Assignee: The Toronto-Dominion Bank, Toronto (CA)

(21) Appl. No.: 16/257,217

(22) Filed: Jan. 25, 2019

(51) Int. Cl. G06Q 40/02; G06K 9/00; G06Q 30/02

(52) U.S. Cl. CPC G06Q 40/025; G06Q 30/0214; G06Q 30/0281; G06K 9/00671

(57) ABSTRACT

A computer-implemented method allows options related to a product to be accessed by capturing an image of a physical item associated with the product. The method includes receiving, from a computing device, an indication (such as an image) of the physical item and identifying the product based on the indication. A referrer associated with the product associated with the physical item is identified. Then, information related to the product and indications of actions related to the product are sent to the computing device. The actions may include an option to apply for the product. An indication that the option to apply for the product has been selected may be received from the computing device. An application for the product may be processed by communicating with the computing device. A record associated with the referrer may updated to reflect that a referral resulted in the application for the product.

### TECHNICAL FIELD

The present application relates to automated information collection and retrieval and, more particularly, to methods for processing applications for products based on associated physical items.

### BACKGROUND

Some products and services may have associated physical objects. An entity that obtains or accesses such a physical object may wish to obtain information about a product and/or file an application for the product. However, locating such information and applications may require manual searching, hindering discovery and ease-of-use. For example, locating and/or completing an application for a given product may require consulting with a human customer service person.

### BRIEF DESCRIPTION OF THE DRAWINGS

Embodiments are described in detail below, with reference to the following drawings:

FIG. 1 is a schematic operation diagram illustrating an operating environment of an example embodiment;

FIGS. 2A and 2B show the front and back of a mobile device, respectively;

FIG. 3 is a high-level schematic diagram of the mobile device of FIGS. 2A and 2B;

FIG. 4 shows a simplified organization of software components stored in a memory of the mobile device of FIGS. 2A and 2B;

FIG. 5 is high-level schematic diagram of a server computing device;

FIG. 6 shows a simplified organization of software components stored in a memory of the server computing device of FIG. 5;

FIG. 7 is a flowchart showing operations performed by the server computing device of FIG. 5 in processing a product application accessed based on a physical item;

FIGS. 8A and 8B show a side of an example physical item;

FIGS. 9A and 9B show a side of another example physical item;

FIG. 10 shows yet another example physical item;

FIG. 11 is a flowchart showing operations performed by a mobile computing device in accessing and providing a product application accessed based on a physical item;

FIG. 12 illustrates how the mobile device of FIGS. 2A and 2B may capture an image of a physical item associated with a product; and

FIG. 13 shows an example user interface for presenting information related to a product.

Like reference numerals are used in the drawings to denote like elements and features.

### DETAILED DESCRIPTION OF VARIOUS EMBODIMENTS

According to the subject matter of the present application, there may be provided a computer server system. The computer server system may include a processor, a communications module, and memory. The communications module and the memory may be coupled to the processor. The memory may store instructions that, when executed by the processor, cause the computer server system to receive, from a remote computing device via a network using the communications module, an indication of a physical item associated with a product. The computer server system may identify the product based on the indication. The computer server system may identify a referrer, the referrer being an entity associated with the product associated with the physical item. The computer server system may send, to the remote computing device via the network using the communications module, information related to the product and indications of one or more actions related to the product. The one or more actions may include an option to apply for the product. The computer server system may receive, from the remote computing device via the network using the communications module, an indication that the option to apply for the product has been selected at the remote computing device. The computer server system may communicate with the remote computing device via the network using the communications module to process an application for the product. The computer server system may update a record associated with the referrer to reflect that a referral by the referrer resulted in the application for the product.

In this way, server computer system may cooperate with a remote computing device such as, for example, a mobile computing device, in order to receive a product application based on a physical item associated with that product. For example, the referrer may be a customer of the product that is associated with the physical item. Conveniently, in this way, an application for a product may be efficiently located and completed.

The physical item may belong to a referrer—an existing entity associated with the physical item. Further to receiving such an application for the product, a record associated with the referrer may be updated to reflect that a referral from the referrer resulted in the application for the product. Such referral data may enable one or more additional facilities related to the product. For example, referral data might be analyzed to understand how “word-of-mouth” may give rise to applications for the product.

In some implementations, the indication may include an image of the physical item associated with the product. It may be that the referrer is identified based on the image of the physical item associated with the product. It may be that identifying the referrer based on the image of the physical item associated with the product may include extracting a referral code from a machine-readable indicium included in the image. The machine-readable indicium may be provided on the physical item.

In some implementations, the instructions, when executed by the processor, may further cause the computer server system to, prior to sending the information related to the product, determine that a user of the remote computing device is not a customer of the product.

In some implementations, the information related to the product may include an indication that, based on previously-collected information, a user of the remote computing device has been pre-approved for the product.

In some implementations, the instructions, when executed by the processor, may further cause the computer server system to: determine, responsive to the application for the product, that an applicant identified in the application qualified for the product; and update a record associated with the referrer to reflect that a referral by the referrer resulted in a qualifying application for the product.

In some implementations, the instructions, when executed by the processor, further cause the computer server system to: determine, responsive to the application for the product, that an applicant identified in the application is not qualified for the product; identify, based on the application for the product, an alternative product that the applicant is qualified for; and send, to the remote computing device via the network using the communications module, information related to the alternative product.

According to the subject matter of the present application, there may be provided a computer-implemented method. The computer-implemented method may include receiving, from a remote computing device via a network, an indication of a physical item associated with a product; identifying the product based on the indication; and identifying a referrer. The referrer may be an entity associated with product associated with the physical item. The computer-implemented method may further include sending, to the remote computing device via the network, information related to the product and indications of one or more actions related to the product. The one or more actions may include an option to apply for the product. The computer-implemented method may further include receiving, from the remote computing device via the network, an indication that the option to apply for the product has been selected at the remote computing device; communicating with the remote computing device via the network to process an application for the product; and updating a record associated with the referrer to reflect that a referral by the referrer resulted in the application for the product.

In some implementations, the indication may include an image of the physical item associated with the product. It may be that the referrer is identified based on the image of the physical item associated with the product. Identifying the referrer based on the image of the physical item associated with the product may include extracting a referral code from a machine-readable indicium included in the image, the machine-readable indicium provided on the physical item.

In some implementations, the computer-implemented method may further include prior to sending the information related to the product, determining that a user of the remote computing device is not a customer of the product.

In some implementations, it may be that the information related to the product includes an indication that, based on previously-collected information, a user of the remote computing device has been pre-approved for the product.

In some implementations, the computer-implemented method may further include determining, responsive to the application for the product, that an applicant identified in the application qualified for the product; and updating a record associated with the referrer to reflect that a referral by the referrer resulted in a qualifying application for the product.

In some implementations, the computer-implemented method may further include determining, responsive to the application for the product, that an applicant identified in the application is not qualified for the product; identifying, based on the application for the product, an alternative product that the applicant is qualified for; and sending, to the remote computing device via the network, information related to the alternative product.

According to the subject matter of the present application, there may be provided a computing device. The computing device may include a processor, an input module, output module, an image capture module, a communications module, and a memory. The input module, the output module, the image capture module, the communications module and the memory may be coupled to the processor. The memory may store instructions that, when executed by the processor, cause the computing device to: capture, using the image capture module, an image of a physical item associated with a product; communicate with a remote computer server system via a network using the communications module to identify the product based on the captured image and to identify a referrer, the referrer being an existing customer of the product associated with the physical item; receive, from the remote computer server system via the network using the communications module, information related to the product and indications of one or more actions related to the product, the one or more actions including an option to apply for the product; present, via the output module, the information related to the product and the one or more actions; receive, via the input module, input selecting the option to apply for the product; and communicate with the remote computer server system via the network using the communications module to process an application for the product, wherein a record associated with the referrer will be updated to reflect that a referral by the referrer resulted in the application for the product responsive to process the application for the product.

In some implementations, the referrer may be identified based on the captured image of the physical item associated with the product.

In some implementations, the information related to the product may include an indication that, based on previously-collected information about a user of the computing device, the user has been pre-approved for the product.

In some implementations, responses to one or more questions associated with the application for the product may be pre-filled based on previously-collected information about a user of the computing device.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

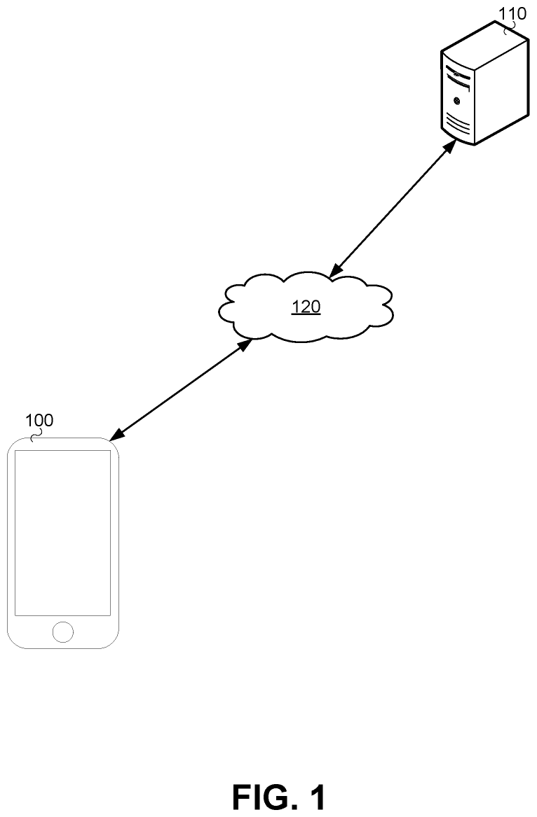

FIG. 1 is a schematic operation diagram illustrating an operating environment of an example embodiment.

As illustrated, a mobile computing device 100 and a computer server system 110 communicate via a network 120.

The mobile computing device 100 and the computer server system 110 may be in geographically disparate locations. Put differently, the mobile computing device 100 may be remote from the computer server system 110 and vice-versa.

The mobile computing device 100 and the computer server system 110 are both computer systems and computing devices.

As further described below, the mobile computing device 100 is adapted to provide access to an application for a product associated with a physical item, with the application being accessed using a physical item associated with that product.

As further described below, the computer server system 110 is adapted to co-operate with computing devices such as the mobile computing device 100 to provide access to an application for a product associated with a physical item.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

As further explained below, the mobile computing device 100 communicates with the computer server system 110 via the network 120 in receive actions related to a product and to selectively initiate such actions.

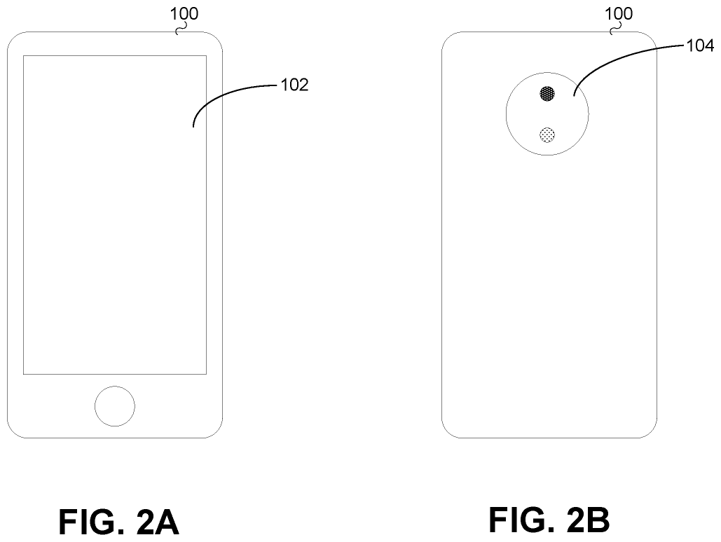

FIGS. 2A and 2B show the front and back of the mobile computing device 100, respectively. The mobile computing device 100 may, in some embodiments, be a smartphone as shown in FIGS. 2A and 2B. In other embodiments, the mobile computing device 100 may be another form of mobile computing device such as, for example, a tablet.

Referring now to FIG. 2A, the front of the mobile computing device 100 includes a display 102. The display 102 is a module of the mobile computing device 100. The display 102 is for presenting graphics. The display 102 may be, for example, a liquid crystal display (LCD). In addition to being an output device, the display 102 may also be an input device. For example, the display 102 may allow touch input to be provided to the mobile computing device 100. In other words, the display 102 may be a touch sensitive display module. In a particular example, the display 102 may be a capacitive touch screen.

Referring to FIG. 2B, the rear of the mobile computing device 100 includes a camera 104. The camera 104 is an image capture module. The camera 104 is for capturing images of the environment of the mobile computing device 100. The camera 104 may incorporate a digital image sensor such as, for example, a charge coupled device (CCD) or a complementary metal-oxide-semiconductor (CMOS) image sensor.

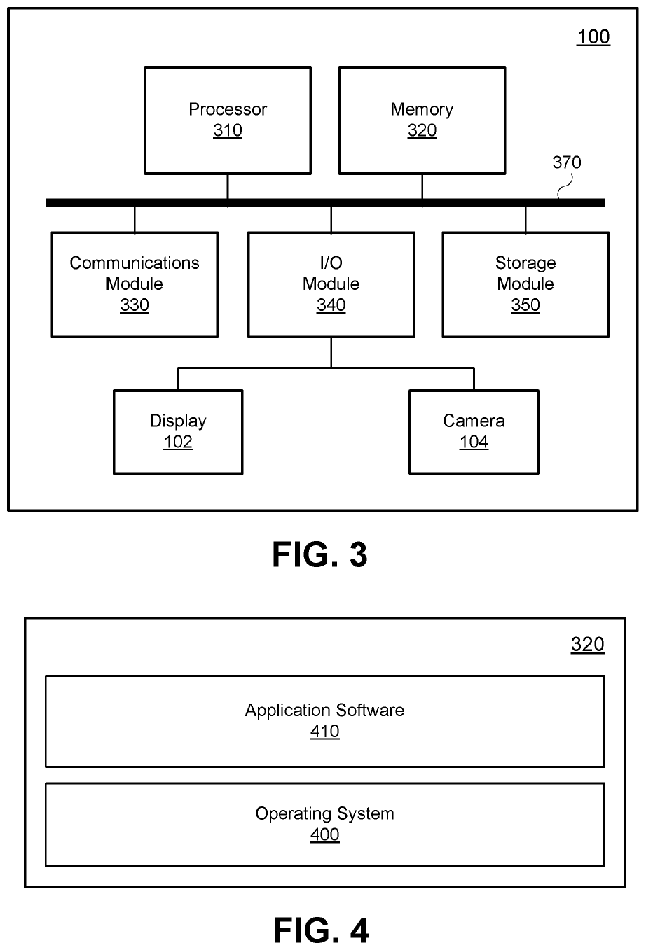

FIG. 3 is a high-level schematic diagram of the mobile computing device 100.

The mobile computing device 100 includes a variety of modules. For example, as illustrated, the mobile computing device 100 may include a processor 310, a memory 320, a communications module 330, and/or a storage module 350. As illustrated, the foregoing example modules of the mobile computing device 100 are in communication over a bus 370.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the mobile computing device 100.

The communications module 330 allows the mobile computing device 100 to communicate with other computing devices and/or various communications networks. For example, the communications module 330 may allow the mobile computing device 100 to send or receive communications signals. Communications signals may be sent or received according to one or more protocols or according to one or more standards. For example, the communications module 330 may allow the mobile computing device 100 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the mobile computing device 100 to communicate using near-field communication (NFC), via Wi-Fi™, using Bluetooth™ or via some combination of one or more networks or protocols. In some embodiments, all or a portion of the communications module 330 may be integrated into a component of the mobile computing device 100. For example, the communications module may be integrated into a communications chipset.

The I/O module 340 is an input/output module. The I/O module 340 allows the mobile computing device 100 to receive input from and/or to provide input to components of the mobile computing device 100. For example, the I/O module 340 may, as shown, allow the mobile computing device 100 to receive input from and/or provide output to the display 102 and/or the camera 104.

The storage module 350 allows data to be stored and retrieved. In some embodiments, the storage module 350 may be formed as a part of the memory 320 and/or may be used to access all or a portion of the memory 320. Additionally or alternatively, the storage module 350 may be used to store and retrieve data from persisted storage other than the persisted storage (if any) accessible via the memory 320. In some embodiments, the storage module 350 may be used to store and retrieve data in/from a database. A database may be stored in persisted storage. Additionally or alternatively, the storage module 350 may access data stored remotely such as, for example, as may be accessed using a local area network (LAN), wide area network (WAN), personal area network (PAN), and/or a storage area network (SAN). In some embodiments, the storage module 350 may access data stored remotely using the communications module 330. In some embodiments, the storage module 350 may be omitted and its function may be performed by the memory 320 and/or by the processor 310 in concert with the communications module 330 such as, for example, if data is stored remotely.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the mobile computing device 100. As illustrated, these software components include an operating system 400 and an application software 410.

The operating system 400 is software. The operating system 400 allows the application software 410 to access the processor 310 (FIG. 3), the memory 320, the communications module 330, the I/O module 340, and the storage module 350 of the mobile computing device 100. The operating system 400 may be, for example, Google™ Android™, Apple™ iOS™, UNIX™, Linux™, Microsoft™ Windows™, Apple OSX™ or the like.

The application software 410 adapts the mobile computing device 100, in combination with the operating system 400, to operate as a device providing information about a product associated with a physical item and access to an application for the product. Where the mobile computing device 100 is a smartphone or tablet, the application software 410 may itself be or may be a part of a smartphone or tablet application or “app”. In a particular example, the application software 410 may be a part of an application associated with the provider of a particular product such as may be associated with a given physical item. For example, where the physical item is a payment card or other finance-related collateral such as, for example, a bank statement, the application software 410 may correspond to an online banking app.

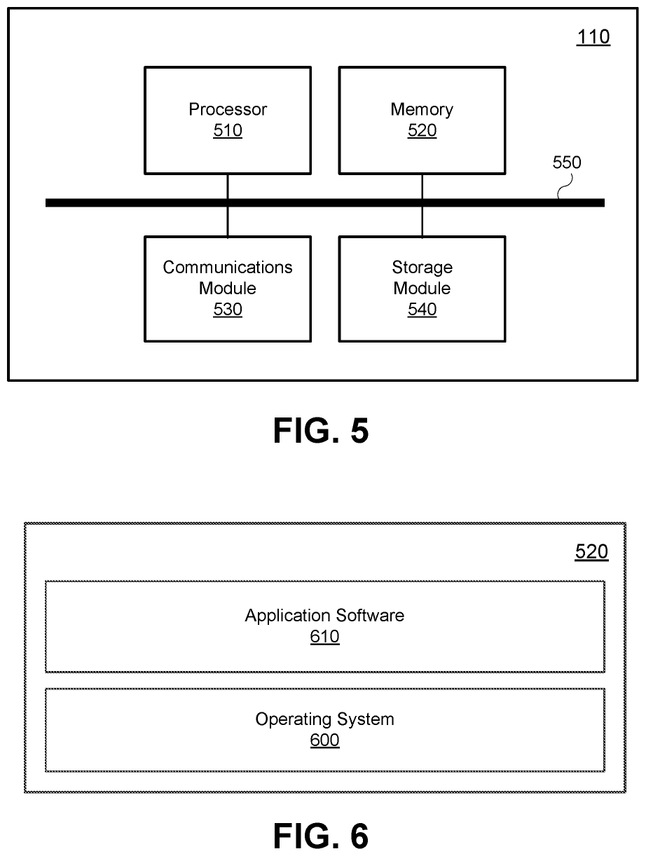

FIG. 5 is a high-level schematic diagram of a computer server system 110.

The computer server system 110 includes a variety of modules. For example, as illustrated, the computer server system 110 may include a processor 510, a memory 520, a communications module 530, and/or a storage module 540. As illustrated, the foregoing example modules of the computer server system 110 are in communication over a bus 550.

The processor 510 is a hardware processor. The processor 510 may, for example, be one or more ARM, Intel x86, PowerPC processors or the like.

The memory 520 allows data to be stored and retrieved. The memory 520 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer server system 110.

The communications module 530 allows the computer server system 110 to communicate with other computing devices and/or various communications networks. For example, the communications module 530 may allow the computer server system 110 to send or receive communications signals. Communications signals may be sent or received according to one or more protocols or according to one or more standards. For example, the communications module 530 may allow the computer server system 110 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 530 may allow the computer server system 110 to communicate via Wi-Fi™, using Bluetooth™ or via some combination of one or more networks or protocols. In some embodiments, all or a portion of the communications module 530 may be integrated into a component of the computer server system 110. For example, the communications module 530 may be integrated into a communications chipset.

The storage module 540 allows the computer server system 110 to store and retrieve data. In some embodiments, the storage module 540 may be formed as a part of the memory 520 and/or may be used to access all or a portion of the memory 520. Additionally or alternatively, the storage module 540 may be used to store and retrieve data from persisted storage other than the persisted storage (if any) accessible via the memory 520. In some embodiments, the storage module 540 may be used to store and retrieve data in a database. A database may be stored in persisted storage. Additionally or alternatively, the storage module 540 may access data stored remotely such as, for example, as may be accessed using a local area network (LAN), wide area network (WAN), personal area network (PAN), and/or a storage area network (SAN). In some embodiments, the storage module 540 may access data stored remotely using the communications module 530. In some embodiments, the storage module 540 may be omitted and its function may be performed by the memory 520 and/or by the processor 510 in concert with the communications module 530 such as, for example, if data is stored remotely.

Software comprising instructions is executed by the processor 510 from a computer-readable medium. For example, software may be loaded into random-access memory from persistent storage of the memory 520. Additionally or alternatively, instructions may be executed by the processor 510 directly from read-only memory of the memory 520.

FIG. 6 depicts a simplified organization of software components stored in the memory 520 (FIG. 5) of the computer server system 110. As illustrated, these software components include an operating system 600 and an application software 610.

The operating system 600 is software. The operating system 600 allows the application software 610 to access the processor 510 (FIG. 4), the memory 520, and the communications module 530 of the computer server system 110 (FIG. 4). The operating system 600 may be, for example, UNIX™, Linux™, Microsoft™ Windows™, Apple OSX™ or the like.

For example, the application software 610 may cooperate with the operating system 600 to adapt a suitable embodiment of the computer server system 110 to provide access to an application for a product associated with a physical item.

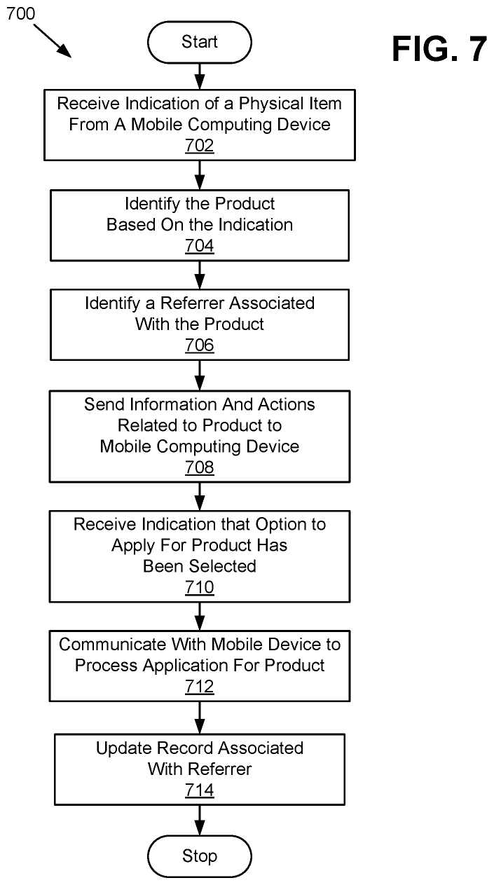

The operation of the computer server system 110 in providing access to an application for a product based on a physical item associated with that product will now be described with reference to a flowchart 700 of FIG. 7. Operations starting from an operation 702 and continuing onward are performed by the processor 510 of the computer server system 110 executing software such as, for example, a suitable instance of the application software 610 (FIG. 6).

At the operation 702, an indication of a physical item associated with a product is received from the mobile computing device 100. The indication may be received via the network 120 such as, for example, using the communications module 530. In some embodiments, the indication may be sent by the mobile computing device 100 via the network 120 using the communications module 330 (FIG. 3).

As further described below, the mobile computing device 100 may capture an image of the physical item associated with the product. Such a product may, as further described below, be provided by an entity referring another to a product. In a particular example, a customer wishing to refer a friend or family member to a particular product may show the friend or family member a physical item that they have that is associated with the particular product. That friend may then use the subject matter of the present application in order to learn about that that product and in order to lodge an application for it so that they might also become a customer of that product.

Notably, the entity receiving the referral may be associated with the mobile computing device 100 such as, for example, where that entity is associated with an operator of the mobile computing device 100. In some embodiments, the indication may correspond to the captured image. For example, the mobile computing device 100 may send the captured image as an indication. In other words, the indication may be or may include an image of the physical item associated with the product. In another example, the mobile computing device 100 may send a portion of the captured image as or as a part of an indication. For example, a relevant portion of the image including identifying information or distinct characteristics or aspects of the physical item may be extracted and sent as an indication. In a particular example, the mobile computing device 100 may extract a value visible on the physical item that identifies the physical item.

Physical items associated with products may take a variety of forms. Among other things, the physical item can be a card or paperwork associated with a product. For example, a physical item may be an ISO-sized card such as, for example, a payment card like a credit or debit card. In another example, physical items may include other forms of payment cards, gym membership cards, insurance or mortgage policy documentation or offer sheets, or the like.

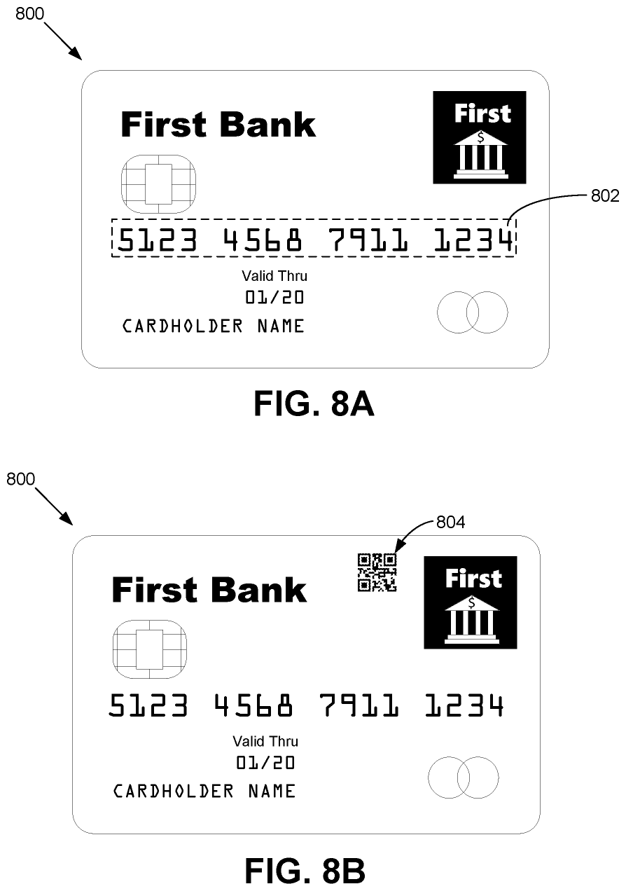

Examples of physical items will now be discussed with reference to FIGS. 8A, 8B, 9A, 9B and 10.

FIGS. 8A and 8B show a front-side of a payment card 800. As shown in FIG. 8A, the payment card 800 includes a printed credit card number 802. Additionally or alternatively, in some cases, the payment card 800 may include a machine readable-indicium such as, for example, a barcode 804 as shown in FIG. 8B. The barcode 804 is shown as a QR-code though this is merely by way of example and other forms of machine-readable indicia may be used including, for example, barcodes using other barcode symbologies such as, for example, PDF417, Code 39 or the like. In another example, machine-readable indicia other than barcodes may, additionally or alternatively, be employed.

An image of the payment card 800 such as may, for example, be captured by the mobile computing device 100 as mentioned above may be analyzed by the mobile computing device 100 to identify features such as the printed credit card number 802 and/or the barcode 804. Such features may then be analyzed to extract an identifier—e.g., the credit card number in the case of the payment card 800. For example, optical character recognition (OCR) techniques may be applied to the image or the portion of the image corresponding to the printed credit card number 802 in order to extract the credit card number. Additionally or alternatively, the barcode 804 may be read using barcode reading techniques as may be known to a skilled person. Software such as, for example the application software 410, may then cause the identifier to be sent to the computer server system 110 by the mobile computing device 100 and then received by the computer server system 110 at the operation 702 (FIG. 2) as mentioned above. In some embodiments, the mobile computing device 100 may send all such identifiers to the computer server system 110. Alternatively, it may be that the mobile computing device 100 selects from amongst possible servers (including the computer server system 110) based on features of the physical item such as, for example, the identifier. In a particular example, a server may be selected based on graphic elements (e.g., a logo) detected in a captured image of the physical item such as, for example, using image detection techniques. In another example, where physical item is a payment card, selection of a server could be based on factors that may be determined based on a number of the card such as, for example, a type of the card and or its issuer. The type of a payment card and or its issuer may be determined is various manners such as, for example, analysis of card numbers that are primary account number (PAN) conforming with the scheme set out in ISO/IEC 7812-1:2017 as further described below.

Additionally or alternatively, portions of a captured image of the payment card 800 containing identifying features such as the printed credit card number 802 and/or the barcode 804 may be extracted and sent to the computer server system 110 instead of or in addition to an extracted identifier.

Notably, where both are sent the computer server system 110 may analyze the received portions of the captured image and compare them to any received extracted identifier. In this way, the extraction of identifiers by the mobile computing device 100 may be verified by the computer server system 110.

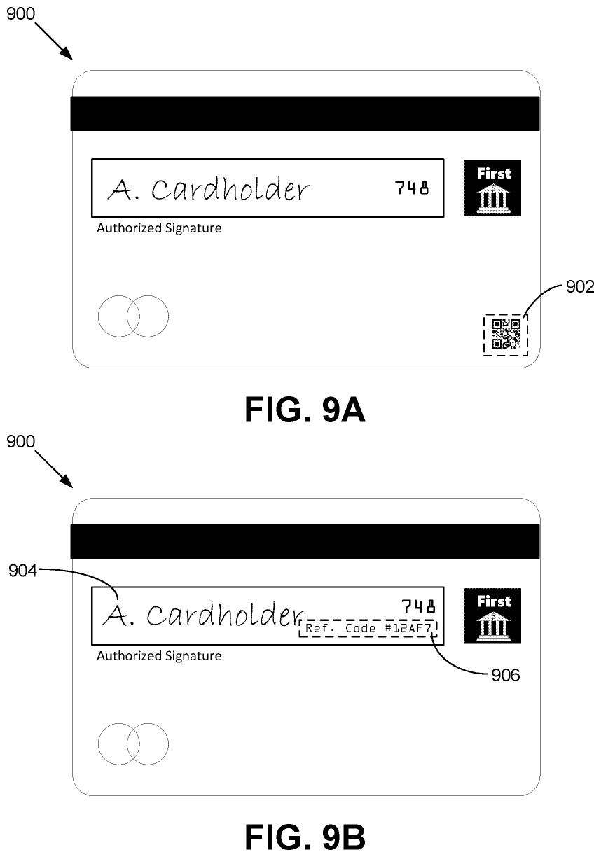

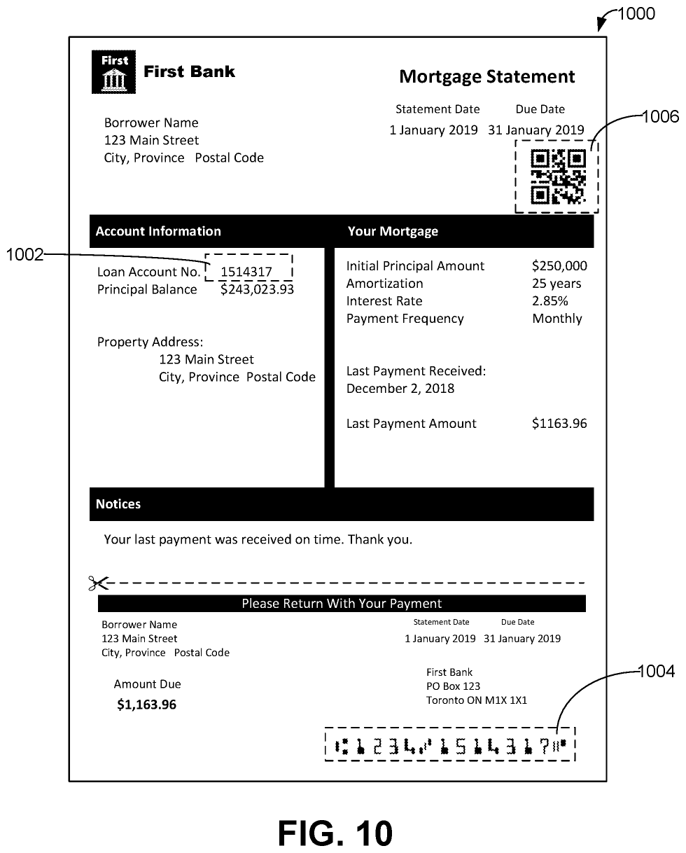

FIGS. 9A and 9B show a back-side of a payment card 900. In some embodiments, it may be that the payment card 800 (FIGS. 8A and 8B) and the payment card 900 are one and the same with FIGS. 8A and 8B and FIGS. 9A and 9B showing opposed sides of the same card, however this is by no means required.

In some embodiments, the number of the payment card 800 (e.g., the value of the printed credit card number 802) may be extracted and analyzed by the mobile computing device 100 and/or the computer server system 110 to determine whether it is associated with an institution and/or a particular card product of an institution allowing referrals. For example, the mobile computing device 100 could perform such an identification prior to communicating an indication of the physical item to the computer server system 110.

Analysis of the number of a payment card 800 may take various forms. For example, the number may be a primary account number (PAN) conforming with the scheme set out in ISO/IEC 7812-1:2017 entitled “Identification cards—Identification of issuers—Part 1: Numbering System”, the contents of which are herein incorporated by reference in their entirety.

The first six digits of a PAN conforming to ISO/IEC 7812-1 are referred to as the issuer identification number (IIN). The IIN is sometimes referred to as the bank identification number (BIN) as banks are common issuers of payment cards. The first digit of the IIN identifies the major industry of the card and is referred to as the major industry identifier (MII). For example, an MII of 4 or 5 identifies a card as being issued by a banking/financial issuer. The remaining 5 digits of the IIN following the MII identify the issuer of a card with a PAN/a PAN in conformance with ISO/IEC 7812-1. A portion of the IIN read together with the MII may serve to identify the issuing network of a card. For example, the PAN (and the IIN) of the payment card 800 begins “51” which identifies the payment card 800 as being associated with the MasterCard™ network. Notably, the issuing network of a card may serve to identify payment networks as may be used to process transactions in association with that card. For example, it may be that transactions involving the payment card 800 are processed using the MasterCard Network. IINs are assigned by a registrar and maintained in a register. In particular, the ISO Register of Issuer Identification Numbers is managed by the American Bankers Association (ABA). Because IINs are managed and registered to particular issuers, the issuer of a payment card such as the payment card 800 may be determined by extracting the IIN from a number associated with the card, namely the PAN. Accordingly, where the physical item is a payment card, it may be that at least the IIN of the PAN is extracted so that the it may be determined whether or not the payment card was issued by a known issuer of payment cards for which referrals may be provided. Additionally or alternatively, a captured image of a payment card could be analyzed using image detection techniques so as to detect graphic elements such as may correspond to a particular issuer (e.g., a logo) or even a particular card product (e.g., a given type of payment card). Then, based on a detected issuer and/or card product, it may be determined whether or not that card product is one eligible for referrals.

Notably, in contrast to the front-side of a payment card, the back-side of a payment card may not include an identifying number of the card usable for making purchases such as, for example, a credit card number such was provided by the printed credit card number 802 (FIG. 8A) and may have been encoded in the barcode 804 (FIG. 8B). Accordingly, a referrer allowing an entity receiving a referral to capture an image of a backside of a payment card may be more favourable from a security perspective as compared to allowing capture of a frontside including an identifying number usable for making purchases. In lieu of such an identifying number, a unique referral code may instead be provided.

In some embodiments, such a referral code may be provided in manners permitting extracting using techniques similar to those discussed above with respect to the credit card number 802 and the barcode 804.

For example, as shown in FIG. 9A, a barcode 902 may be provided such as may act as a machine-readable indicium encoding a referral code, in this case “12AF7”. The barcode 902 is shown as a QR code however, as discussed above with regards to the barcode 804, other barcode symbologies or, more broadly, other forms of machine-readable indicia may, additionally or alternatively, be employed.

Additionally or alternatively, a printed referral code akin to the printed credit card number 802 could be provided. For example, as shown, a printed referral code 906 could be provided atop the signature strip 904. Additionally or alternatively, such a printed referral code could be provided on other portions of the payment card 900 including potentially on the opposite (i.e., front) side of the payment card 900.

The manners of encoding identifying features in a physical item and extracting values therefrom discussed above are given as examples. Other manners of encoding and extracting values may be employed in implementing the subject matter of the present application. Furthermore, the above discussion of payment cards is merely by way of example and all such techniques for encoding and extracting values from images of physical items, including those described above by way of example, may be employed with physical items other than payment cards.

For example, FIG. 10 shows how various of the above-described techniques may be employed with respect to a printed document. FIG. 10 shows a mortgage statement 1000.

The mortgage statement 1000 includes a loan account number in multiple places, namely a loan account number 1002 in an account information portion of the statement and a magnetic ink character recognition (MICR) encoded loan account number 1004 in a remittance slip portion of the mortgage statement 1000. Notably, one or both of the loan account number 1002 and the MICR-encoded loan account number 1004 may be analyzed in manners similar to the printed credit card number 802 of FIG. 8A and the printed referral code 906 of FIG. 9B. For example, one or both of such portions of the mortgage statement 1000 could be located in a captured image of the mortgage statement 1000 and then analyzed to obtain the account number value which could then be provided as an indication by the mobile computing device 100 to the computer server system 110. Additionally or alternatively, such portions of a capture image could be provided as an indication in manners similar to as were discussed above with regards to the printed credit card number 802 and the printed referral code 906.

Additionally or alternatively, the mortgage statement 1000 may include a machine-readable indicium such as may provide a referral code and/or the loan account number. As illustrated, such an indicium may take the form of a barcode 1006. The barcode 1006 is a QR code but other barcode symbologies or other forms of machine-readable indicia may, additionally or alternatively, be employed similar to as was discussed above with regards to the barcode 804 (FIG. 8B) and the barcode 902 (FIG. 9A). Furthermore, the barcode 1006 may be extracted from a captured image of the mortgage statement 1000 and then analyzed in manners similar to as were discussed above with regards the extraction and analysis of the barcode 804 and the barcode 902.

In yet another example of a physical item, it may be that a physical item associated with the product is supplied to existing customers expressly for the purpose of providing to others as a part of giving a referral. For example, a customer could be provided with a printed referral card or letter such as may include identifying information allowing identification of that customer as a referrer. For example, a customer may be provided with such a physical item by allowing the customer to print the physical item and/or by sending a printed copy to the customer such as, for example, via post. Such a printed item may include, similar to as were discussed above, one or more identifying numbers/codes (e.g., referral codes) and/or one or more machine-readable indicia.

Elements of a physical item such as, for example, identifying numbers, machine-readable indicia, etc. may be located or detected in captured images of physical items in a variety of manners. For example, it may be that a particular physical item is detected based on the presence of a particular logo, symbol, or the like. Additionally or alternatively, numbers, indicia, etc. may be located within a captured image of a physical item (e.g., the positions of such elements may be determined) based on the detection of other elements of a physical item. For example, items such as, for example, logos or other features of an item may be used as landmarks. For example, in the particular case of a payment card, an EMV-chip of a “chip card”, an issuer and/or card network symbol or logo, or a magnetic stripe could be considered examples of possible landmarks with known positions on a card that may be detected in a captured image using image recognition techniques and then used in locating elements such as numbers, machine-readable indicia, etc. . . .

Returning now to FIG. 7, following the operation 702, an operation 704 is next.

At the operation 704, the product is identified based on the indication received at the operation 702.

Where the indication is or includes one or more images, identifying the product may include an analysis of the one or more images. For example, an image may be analyzed using OCR to extract an identifier and/or to read a machine-readable indicium in manners such as were discussed above regarding FIGS. 8A, 8B, 9A, 9B and 10.

In some embodiments, the received indication will include values such as may be based on such identifiers and/or machine-readable indicia such as, for example, where analysis of one or more images was performed at the mobile computing device 100.

However obtained, values obtained from printed identifiers, machine-readable indicia and the like may be used to perform a look-up such as, for example, against one or more databases in order to identify corresponding products. For example, in the case of the payment card 800 (FIGS. 8A-8B), the credit card number may be looked-up in a financial institution database in order to identify the type of the card.

A similar look-up could be performed based on a referral codes such as those discussed in relation to the payment card 900 (FIGS. 9A-9B).

In some embodiments, the received indication may include an identification of the product directly. For example, it could be the mobile computing device 100 determines the type of product directly such as, for example, through the use of image recognition techniques to identify a product directly based on a captured image of a physical item associated with a given product. Additionally or alternatively, the mobile computing device 100 may extract values from a captured image of a physical item (e.g., from printed identifiers, and/or machine-readable indicia, etc.) and may then perform a lookup using those values against one or more databases before communicating resulting information (e.g., an identification of the product) as or included in the indication received at the operation 702. For example, the mobile computing device 100 may communicate with one or more other computing devices via a network (e.g., a database server) to perform one or more lookups based on extracted values before then sending the indication received at the operation 702 based results of such lookups.

Following the identification of the product at the operation 704, an operation 706 is next.

At the operation 706, a referrer associated with the product is identified. The referrer is an entity associated with the product associated with the physical item. For example, the referrer may be a customer of the product such as, for example, an individual or a juristic entity like a corporation. The identification of the referrer may be based on the indication received at the operation 702. For example, the identification could be based on information obtained at the operation 704 such as may have, for example, been extracted from one or more image or obtained via one or more database queries (lookups) as discussed above. In another example, where the indication received at the operation 702 is or includes an image of the physical item associated with the product, it could be that the referrer is identified based on that image of the physical item associated with the product. For example, identifying the referrer may include extracting a referral code as described above such as, for example, from a machine-readable indicium included in the image, the machine-readable indicium being one provided on the physical item and included in the image.

Similar to as was discussed above with regards to the operation 706, identification of a referrer may include one or more database lookups. For example, in the case where the physical item is a payment card (e.g., like the payment card 800) or paperwork associated with an account (e.g., like the mortgage statement 1000), a customer information database may be queried to identify a profile with information about an account holder with an account for the associated product. Such an account holder may then be considered the referrer.

Following the operation 706, an operation 708 is next.

At the operation 708, the computer server system 110 sends information related to the product as well as indications of one or more actions related to the product to the mobile computing device 100 via the network 120. For example, the information and indications of actions may be sent using the communications module 530.

The one or more actions may include an option to apply for the product. For example, where the product is a credit card, the option could be an option to apply for the same card. In another example, where the product is a mortgage, the option could be an option to apply for a mortgage of the same type. In another example, the one or more actions may also include other options related to the product such as, for example, an option to receive more information about the product, and/or an option to apply for, purchase, and/or receive information about one or more related products.

In some embodiments, prior to sending the information and action, it may be determined whether or not a user of the mobile computing device 100 is a customer of the product. For example, information about a user of the mobile computing device 100 (e.g., an email address or other identifying information of the user) and/or information about the mobile computing device 100 (e.g., an identifying number such as, for example, a device serial number an International Mobile Equipment Identity (IMEI) number and/or a Subscriber Identity Module (SIM) card Integrated Circuit Card Identifier (ICCID)) may be provided to a server such as, for example, the computer server system 110 in order to identify the user. Once so identified, a lookup may be performed by that server and/or by another server based on a token or user identifier provided by that server in order to determine whether a user of the mobile computing device 100 is already a customer of the product. In some cases, such as, for example, where the user of the mobile computing device 100 is already a customer of the product, an option to apply may not be provided, whereas such an option may be provided where that user is not a customer of the product.

In addition to providing an option to apply, it may be that the information includes one or more reasons or incentives for applying for the product. In a particular example, it could be that a user has logged in or authenticated to the mobile computing device 100 and that the computer server system 110 uses the identify of that user to access a profile of the user. The profile may then be used to provide customized or personalized offers related to the particular product such as, for example, sign-up promotional offers such as may, for example, induce the user to lodge an application.

Following the operation 708, an operation 710 is next.

At the operation 710, an indication that the option to apply for the product has been selected at the mobile computing device 100 is received.

For example, it may be that the options were presented at the mobile computing device 100 such as, for example, via an output device and input selecting that option was then received at the mobile computing device 100 responsive to that presentation. In a particular example, such output could be presented by way of the display 102 (FIGS. 2 and 3) and then the input received by way of some input module in communication with the I/O module 340. Then, responsive to the received input, the indication received at the operation 710 may be sent by the mobile computing device 100 to the computer server system 110.

Following the operation 710, an operation 712 is next.

At the operation 712, the computer server system 110 communicates with the mobile computing device 100 via the network 120 to process an application for the product. For example, the computer server system 110 may send one or more requests for information required to prepare the application to the mobile computing device 100 and the mobile computing device 100 may collect the requested information and reply to the computer server system 110 providing the collected information. In a particular example, the computer server system 110 may send one or more forms to the mobile computing device 100 and the mobile computing device 100 may then present the forms such as, for example, via the display 102 (FIGS. 2 and 3). The forms may then be completed such as, for example, based on received input and/or information available on or to the mobile computing device 100 and then the information collected in the forms may be provided to the computer server system 110 by the mobile computing device 100 via the network 120. In some embodiments, the computer server system 110 may then initiate adjudication of the application and/or automatically adjudicate the application. Further, it may be that an adjudication result is obtained and that result may be provided to the mobile computing device 100 via the network 120 such as, for example, for presentation via the display 102.

In some embodiments, it could be determined that a user of the mobile computing device 100 has been pre-approved for the product. For example, it could be that the user has logged in or authenticated to the mobile computing device 100 and that a profile of the user is used to access information including previously-collected information about the user. Such information may be used in order to determine that the user has been previously pre-approved. Additionally or alternatively, it could be that such information is used to “instantly” approve the user for the product in real-time or near real-time. In such circumstances, communicating with the mobile computing device 100 to process an application for the product may involve providing an indication of the pre-approval and/or the outcome of the instant approval processing. In yet another example, it could be that such previously-collected information and/or other information about a user is used to partially pre-fill an application for the product.

In some embodiments, information about the user may be used to determine that the customer is not in the target market for the product. For example, it may be that the user's profile suggests that they will not qualify for the product (i.e., their application will likely be rejected). In another example, it may be that the user's profile suggests that they are eligible for a related, higher-tier product with similar features. In a particular example, where the product is a credit card, the higher-tier product may be a premium product of the same card product family. In such scenarios, information about one or more alternative products (such as, for example, higher or lower-tier related products) may be provided to the mobile computing device 100 in addition to or as an alternative to information about the product associated with the physical item. Additionally, it could be that the actions include options to apply for the one or more alternative products either in addition to or as an alternative to the product associated with the physical item.

Following the operation 712, an operation 714 is next.

At the operation 714, a record associated with the referrer identified at the operation 706 is updated to reflect that referral by the referrer result in an application for the product. For example, the record may be a record in a database. In some embodiments, the record may reflect an adjudication outcome or status for the application—e.g., application was accepted, deferred for further consideration, rejected, etc. . . .

It may be that the computer server system 110 determines, responsive to the application for the product, that an applicant identified in the application (which could, for example, be a user of the mobile computing device 100) qualified for the product. In such cases, a record associated with the referrer could be updated to reflect that a referral by the referrer resulted in a qualifying application for the product—i.e., not only was a potential customer referred to the product by the referrer but also that potential customer successfully signed-up for the product.

Alternatively, it could be that, in some embodiments, the computer server system 110 determines, responsive to the application for the product, that an application identified in the application was not qualified for the product. It could be that the computer server system 110 then identifies an alternative product that the applicant is actually qualified for or may qualify for. In a particular example, it may be that the applicant is identified as not being in the target market for the applied-for product.

An indication of that alternative product may be provided to the mobile computing device 100 by the computer server system 110. Such an indication may be or may include information related to the alternative product. The mobile computing device 100 could then present that information and, potentially, handle a request to apply for the alternative product. In some embodiments, the applicant may be pre-approved for the alternative product such as, for example, based on the information provided in the earlier application for the product associated with the physical item. Additionally or alternatively, the computer server system 110 and the mobile computing device 100 may communicate in manners described above in order to process an application for the alternative product.

As noted above, at the operation 714, a record associated with the identified referrer is updated to reflect that referral by the referrer result in an application for the product. For example, it may be that a database record is updated to reflect an increase in a value of an account. This may, for example, correspond to providing a referral bonus to the referrer. The database record may correspond to credits, discount, points, or some other consideration or incentive, financial or otherwise, and incrementing that record may correspond to providing a bonus in such forms. In some embodiments, such an increment may only be performed responsive to a successful application based on a referral (e.g., an application that was based on approval and was approved). This may, for example, correspond to only providing bonus for referrals resulting in successful applications.

In some embodiments, prior to performing an increment, the referrer may be required to perform a task and/or to take some action. For example, the computer server system 110 could contact the referrer and ask the referrer to confirm the identity of the referrer. Conveniently, in this way, a referrer, who may already be known to the offeror of a product, may be enlisted to assist in identity verification of new customers such as, for example, in order to comply with “know your client” (KYC) type regulatory requirements.

In some embodiments, relationships between customers may be determined based on referrals. This information may allow how word-of-mouth results in growth to be understood for a particular product. Additionally or alternatively, such information may allow targeted offers to be provided. For example, it could be that offers of new products are provided to customers based on products being used by one or more other customers from whom they have previously received (or to whom they have previously provided) a referral.

In some embodiments, further to a referral, in addition or as an alternative to updating a record associated with the identified referrer to reflect that referral by the referrer resulted in an application for the product, one or more other actions may be performed in cases where referrals result in an application for a product and/or where referral result in a successful application for a product. For example, where the applied-for-product is a phone plan, upon approval, the referrer could be added to a phone book or calling circle of the applicant. Additionally or alternatively, where the applied-for-product is associated with a bank account such as, for example, where the applied-for product is a payment account or other payment product, the referrer could be added to as a pre-configured payee for the applicant.

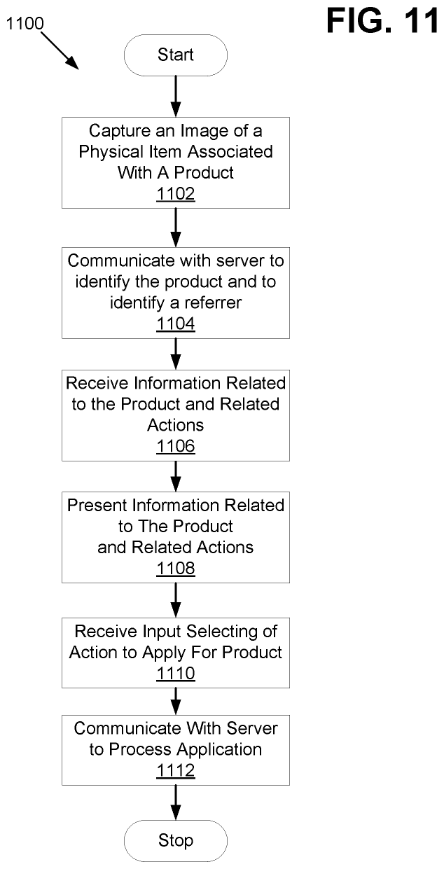

Operations performed by the mobile computing device 100 will be described below with reference to FIG. 11.

The operation of the mobile computing device 100 in providing access to an application for a product with based on a physical item associated with that product will now be described with reference to a flowchart 1100 of FIG. 11. Operations starting from an operation 1102 and continuing onward are performed by the processor 310 of the mobile computing device 100 executing software such as, for example, a suitable instance of the application software 410 (FIG. 4).

At the operation 1102, an image of a physical item associated with a product is captured using the mobile computing device 100. Such an image will be an image of a portion of an environment including the physical item. The image may be captured by the mobile computing device 100 using the camera 104 (FIGS. 2B and 3).

It may be that the image of the physical item is captured responsive to user input. A user interface may be provided by the mobile computing device 100 allowing a user of the mobile computing device 100 to collect the image.

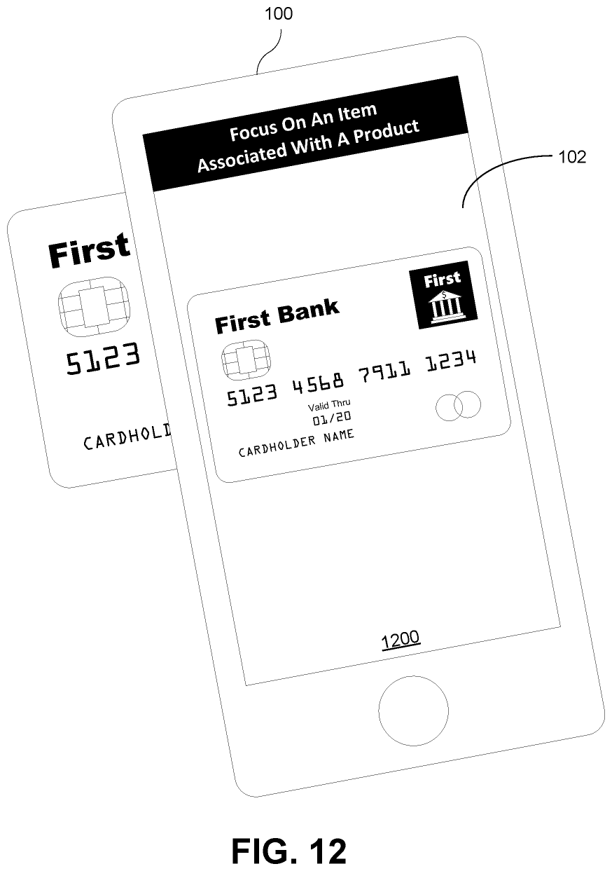

FIG. 12 shows an example user interface 1200 as may be displayed on the display 102 of the mobile computing device 100 is. As illustrated, the example user interface 1200 instructs the user to focus the camera 104 (FIGS. 2B and 3) of the mobile computing device 100 on a physical item associated with a product. As shown, a preview of the image may then be provided on the display 102. In some embodiments, an image may be automatically captured. For example, it could be that an image is captured once a likely physical item has been detected. Additionally or alternatively, the example user interface 1200 may include a user interface control (not shown) allowing a user to capture an image once satisfied with the preview.

Returning to FIG. 11, following the operation 1102, an operation 1104 is next.

At the operation 1104, the mobile computing device 100 communicates with the computer server system 110 via the network 120 to identify the product on the captured image and to identify a referrer. For example, the mobile computing device 100 may send such communications using the communications module 330. As discussed above, the referrer is an existing customer of the product associated with the physical item.

Communicating with the computer server system 110 may include sending to the computer server system 110 an indication based on the image captured at the operation 1102. Such an indication may correspond to the indication received by the computer server system 110 at the operation 702 (FIG. 7) as described above. For example, the indication may include the image captured at the operation 1102 and/or information based on that image or extracted therefrom such as was described above. Based on such an indication, the computer server system 110 may identify the product and/or the referrer. Alternatively, the mobile computing device 100 may identify one or both of the product and the referrer and provide that information to the computer server system 110.

Following the operation 1104, an operation 1106 is next.

At the operation 1106, the mobile computing device 100 receives, from the computer server system 110 via the network 120, information related to the product and indications of one or more actions related to the product. For example, the information and actions may be received using the communications module 330 (FIG. 3). The one or more actions may include an option to apply for the product. The operation 1106 corresponds to the mobile computing device 100 receiving information and actions sent by the computer server system 110 as discussed in the description of the operation 708 (FIG. 7) above. Accordingly, as discussed above, information about other products and actions related to those products may, additionally or alternatively be provided, such as, for example, information related to alternative products. Further, as noted above, it may be that the information related to the product includes an indication that, based on previously-collected information about a user of the mobile computing device 100, the user has been pre-approved for the product.

Following the operation 1106, an operation 1108 is next.

At the operation 1108, the information and actions related to the product are presented by the mobile computing device 100. For example, the information and actions may be presented via an output device such as the display 102 (FIGS. 2, 3).

In some embodiments, such as, for example, where the image of the physical item is automatically captured, the information and actions may be presented in augmented reality by overlaying interface elements presenting the information and actions on the captured image such as, for example, over portions of the image corresponding to the physical item and/or over other portions of the image. Further, it may be that when the mobile computing device 100 is moved relative to the environment, additional images of portions of the environment are captured and the displayed image is updated with the overlaid interface elements being repositioned or even hidden as the overlaid aspects of the image move about or outside the view frame of the captured image—i.e., depending on whether the portions of the product/other parts of the environment being replaced by/overlaid with interface elements are in or not in the portion of the environment reflected in a given captured image.

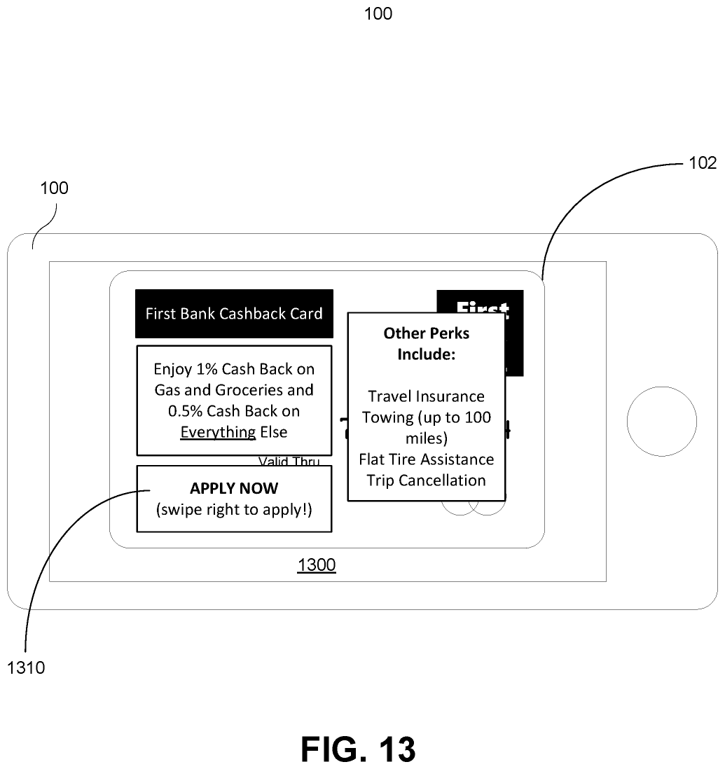

FIG. 13 shows an example augmented reality user interface 1300 related to a cashback credit card product. As illustrated, the user interface elements present information related to the product overlaid on the physical item related to the product, namely a referrer's credit card. The display of the augmented reality user interface 1300 may be presented by compositing the image of the portion of the environment including the physical item as may have been captured at the operation 1102 with one or more graphical, interactive user interface controls forming the augmented reality user interface 1300. For example, as shown, an option to apply for the card may provided by way of a user interface element 1310 and, in some embodiments, the presenting the display of the augmented reality user interface 1300 may include compositing an image of the user interface element 1310 with one or more captured images of portions of an environment.

The user interface element 1310 may be positioned in a defined position in augmented reality relative to the physical item. Such a defined position may be identified in a variety of manners. For example, it may be that in the image captured of the portion of the environment, one or more visual elements of the physical item (i.e., elements visible on the physical item when viewed) may be identified. Locating elements may correspond to or be akin to the locating of landmarks for locating elements of a physical item in captured images of physical items that was discussed above. For example, where the physical item is a credit card or another payment card, such elements may include, visible aspects of such cards such, one or more of the embossed or printed credit card number, logos printed on the card, and/or the EMV smart-chip on the front of a “chip” card and/or aspects such as, for example, a signature strip and/a magnetic strip on the backside of the card. Notably, by detecting positions of one or more such elements, the defined position in the image of the portion of the environment may be determined based on the positions of the identified one or more visual elements. For example, it may be that user interface elements such as, for example the user interface element 1310, are to be positioned in a pre-determined position above, below, besides, and/or between one or more of the identified visual elements such as, for example, at a particular distance relative to features of one or more such elements (e.g., the centres and/or edges thereof).

In some embodiments, the mobile computing device 100 may continuously capture images of portions of the environment within which the mobile computing device 100 is located thereby allowing the augmented reality user interface 1300 to be re-rendered taking into account movement of the mobile computing device 100 and/or the physical item relative to each other and/or the environment. In particular, the augmented reality user interface 1300 may be re-rendered relative as new images of portions of the environment are captured.

A user may interact with user interface elements of the augmented reality user interface 1300 to perform operations. For example, a user may interact with the user interface element 1310 to begin applying for the card. In some embodiments, it may be that user interaction is monitored based on captured images of the environment including the physical item. For example, images of portions of the environment may be captured using the camera 104. In any event, using captured images of the portions of the environment, a user's hand (and in particular fingers) moving in or about a physical item may be detected and, more particularly, in areas of the environment corresponding to areas in augmented reality as are on or about a particular user interface element. In this way, touching or hovering of a user's fingers (so as to effectively interact in augmented reality with the user interface control) may be detected and treated as a form of input. Such input may then be processed in manners similar to touch input.

In some embodiments, detected fingers may be rendered atop user interface elements. In other words, during composition of an image of a given aspect of a user interface with an image of the portion of the environment including the physical item, the user interface element may be overlaid atop the image of the portion of the environment in the defined position except that portions of the user interface element as may occlude fingers of a user in the image of the portion of the environment may not be included in the composited image, thereby allowing the fingers to remain visible in the resultant composited image.

In another example of receiving input, where the display 102 is a touchscreen, a user may touch the display 102 within the area defined by a given user interface control in order to select options and/or perform actions such as, for example, beginning the application process using the user interface element 1310.

Returning to FIG. 11, following the operation 1108, an operation 1110 is next.

At the operation 1110, the mobile computing device 100 receives input selecting an action to apply for the product. The input may be received via one or more input devices such as, for example, by way of the I/O module 340 (FIG. 3). In a particular example, in the case of the example augmented reality user interface 1300, it could be that input was receiving selecting that element by swiping right on the display 102 such as, for example, by a user swiping with their finger where the display 102 is a touchscreen.

Following the operation 1110, an operation 1112 is next.

At the operation 1112, the mobile computing device 100 communicates with the computer server system 110 via the network 120 to process an application for the product. The operation 1112 corresponds to the operation 712 of FIG. 7 above. As such, further to the operation 1112—as described above in relation to operations 712 and 714 and, in particular, the operation 714—a record associated with the referrer may be updated by the computer server system 110 to reflect that a referral by the referrer resulted in an application for the product responsive to process the application for the product. As discussed above, in some embodiments, responses to one or more questions associated with application for the product (e.g., form fields) may be pre-filled based on previously-collected information about a user of the mobile computing device 100.

In some embodiments, it may be that the capture of the image of a physical item associated with a product and the communicating with the server to identify the product and identify the referrer may be temporally disparate from the communicating with the server to process an application—e.g., the operations 1102 and 1104 may be temporally disparate from the operation 1112 and, potentially, one or more of the operations 1106, 1108 and 1110. For example, it could be that at a first time, a referral is performed encompassing performance of operations 1102 and 1102. This may then cause information related to the product and/or related actions to be received at a later, second time by way of a communication or notification such as, for example, an email and/or a notification as may be provided at the mobile computing device 100. Additionally or alternatively, it may be that information and/or actions are provided at the first time, but are again provided at a second time such, as for example, by providing a reminder if no application was processed at the first time. In a particular example, an email reminder or notification may provide or include a link allowing a webpage to be visited and/or a suitable application to be launched on the mobile computing device 100 to, for example, allow an application to be processed such as, for example, in manners as were described above in relation to the operation 1112.

Additionally or alternatively, it may be that the capture of the image of a physical item associated with a product and the communicating with the server to identify the product and identify the referrer may involve a first mobile computing device and that the communicating with the server to process an application may involve a second mobile computing device—e.g., the operations 1102 and 1104 may be performed by the first mobile computing device and the operation 1112 and, potentially, one or more of the operations 1106, 1108 and 1110 may be performed by the second mobile computing device. For example, it could be that, as mentioned above, further to the operations performed by first mobile computing device, an email and/or a notification may be provided including a link and, in particular, provided to (e.g., sent to) the second mobile computing device. It could then be that such an email and/or notification is received at the second mobile computing device and that link is then followed allowing an application to be processed by way of a webpage or suitable application. Conveniently, such an arrangement could provide improved privacy and or security. For example, a referrer may use his or her own device to capture an image of the physical item and to initiate the referral and then the referred entity may review information, process an application, using their own personal and/or trusted device. In this way, the security of the referrer's physical item may be preserved. For example, the referrer may avoid providing the referee with an image showing details of the physical item which may be particularly desirable when such an image could have privacy and/or security implications such as, for example, in where the physical item is a payment card. Additionally or alternatively, employing a second mobile device in processing an application may allow the privacy of an application by a referred person (the referee) to be protected by allowing the referred person to use a device they trust to make an application.

As described above, the mobile computing device 100 communicates directly with the computer server system 110 to identify the product and to identify the referrer, to receive information and actions related to the product and to process an application. In some embodiments, the mobile computing device 100 may, alternatively, communicate with more than one server in performing various functions. For example, it could be that a first server is involved in identifying the product and/or the referrer and then other server/servers such as may, for example, be associated with the product, are involved in providing information and actions related to the product and/or processing applications for the product.

In the above discussion, the terminology “apply” and “application” for a product is used to refer to the process of a referee choosing to proceed with obtaining the product to which they have been referred. As mentioned above, the subject matter of the present application may be employed in relation to products for which an application is processed and may be accepted and rejected such as, for example, payment cards, financial products like mortgages, bank accounts, etc., as well as other types of non-banking products such, as for example, post-paid phone plans and insurance products. However, the subject matter of the present application is not limited to situations involving applications for products that require adjudication. For example, the subject matter of the present application could be employed in relation to products that a person may sign-up without any question of determining if they are suitable and/or qualified for the product such as, for example, products like a pre-paid phone plan, a gym membership, a magazine subscription etc. . . . In other words, processing an “application” for a product may, in some embodiments, correspond to a sign-up or enrollment workflow or, more broadly, to initiating a purchase for a product such as, for example, a subscription product like a magazine or certain software, rather than the lodging of an application for adjudication.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer server system comprising:
a processor;
a communications module coupled to the processor;
a memory coupled to the processor and storing instructions that, when executed by the processor, cause the computer server system to:
receive, from a remote computing device via a network using the communications module, an indication of a physical item associated with a product;
identify the product based on the indication;
identify a referrer, the referrer being an entity associated with the product associated with the physical item;
send, to the remote computing device via the network using the communications module, information related to the product and indications of one or more actions related to the product, the one or more actions including an option to apply for the product;
receive, from the remote computing device via the network using the communications module, an indication that the option to apply for the product has been selected at the remote computing device;
communicate with the remote computing device via the network using the communications module to process an application for the product; and
update a record associated with the referrer to reflect that a referral by the referrer resulted in the application for the product.

2. The computer server system of claim 1, wherein the indication includes an image of the physical item associated with the product.

3. The computer server system of claim 2, wherein the referrer is identified based on the image of the physical item associated with the product.

4. The computer server system of claim 3, wherein identifying the referrer based on the image of the physical item associated with the product includes extracting a referral code from a machine-readable indicium included in the image, the machine-readable indicium provided on the physical item.

5. The computer server system of claim 1, wherein the instructions, when executed by the processor, further cause the computer server system to:
prior to sending the information related to the product, determine that a user of the remote computing device is not a customer of the product.

6. The computer server system of claim 1, wherein the information related to the product includes an indication that, based on previously-collected information, a user of the remote computing device has been pre-approved for the product.

7. The computer server system of claim 1, wherein the instructions, when executed by the processor, further cause the computer server system to:
determine, responsive to the application for the product, that an applicant identified in the application qualified for the product; and
update a record associated with the referrer to reflect that a referral by the referrer resulted in a qualifying application for the product.

8. The computer server system of claim 1, wherein the instructions, when executed by the processor, further cause the computer server system to:
determine, responsive to the application for the product, that an applicant identified in the application is not qualified for the product;
identify, based on the application for the product, an alternative product that the applicant is qualified for; and
send, to the remote computing device via the network using the communications module, information related to the alternative product.

9. A computer-implemented method comprising:
receiving, from a remote computing device via a network, an indication of a physical item associated with a product;
identifying the product based on the indication;
identifying a referrer, the referrer being an entity associated with the product associated with the physical item;
sending, to the remote computing device via the network, information related to the product and indications of one or more actions related to the product, the one or more actions including an option to apply for the product;
receiving, from the remote computing device via the network, an indication that the option to apply for the product has been selected at the remote computing device;
communicating with the remote computing device via the network to process an application for the product; and
updating a record associated with the referrer to reflect that a referral by the referrer resulted in the application for the product.

10. The computer-implemented method of claim 9, wherein the indication includes an image of the physical item associated with the product.

11. The computer-implemented method of claim 10, wherein the referrer is identified based on the image of the physical item associated with the product.

12. The computer-implemented method of claim 11, wherein identifying the referrer based on the image of the physical item associated with the product includes extracting a referral code from a machine-readable indicium included in the image, the machine-readable indicium provided on the physical item.

13. The computer-implemented method of claim 9, further comprising:
prior to sending the information related to the product, determining that a user of the remote computing device is not a customer of the product.

14. The computer-implemented method of claim 9, wherein the information related to the product includes an indication that, based on previously-collected information, a user of the remote computing device has been pre-approved for the product.

15. The computer-implemented method of claim 9, further comprising:
determining, responsive to the application for the product, that an applicant identified in the application qualified for the product; and
updating a record associated with the referrer to reflect that a referral by the referrer resulted in a qualifying application for the product.

16. The computer-implemented method of claim 9, further comprising;
determining, responsive to the application for the product, that an applicant identified in the application is not qualified for the product;
identifying, based on the application for the product, an alternative product that the applicant is qualified for; and
sending, to the remote computing device via the network, information related to the alternative product.

17. A computing device comprising:
a processor;
an input module coupled to the processor;
an output module coupled to the processor;
an image capture module coupled to the processor;
a communications module coupled to the processor; and
a memory coupled to the processor and storing instructions that, when executed by the processor, cause the computing device to:
capture, using the image capture module, an image of a physical item associated with a product;
communicate with a remote computer server system via a network using the communications module to identify the product based on the captured image and to identify a referrer, the referrer being an existing customer of the product associated with the physical item;
receive, from the remote computer server system via the network using the communications module, information related to the product and indications of one or more actions related to the product, the one or more actions including an option to apply for the product;
present, via the output module, the information related to the product and the one or more actions;
receive, via the input module, input selecting the option to apply for the product; and
communicate with the remote computer server system via the network using the communications module to process an application for the product, wherein a record associated with the referrer will be updated to reflect that a referral by the referrer resulted in the application for the product responsive to process the application for the product.

18. The computing device of claim 17, wherein the referrer is identified based on the captured image of the physical item associated with the product.

19. The computing device of claim 17, wherein the information related to the product includes an indication that, based on previously-collected information about a user of the computing device, the user has been pre-approved for the product.

20. The computing device of claim 17, wherein responses to one or more questions associated with the application for the product are pre-filled based on previously-collected information about a user of the computing device.
